(19) United States
(12) Patent Application Publication
(10) Pub. No.: US 2026/0068015 A1
(43) Pub. Date: Mar. 5, 2026

(54) LAMP CONTROL METHOD, CHIP, STORAGE MEDIUM, COMPUTER PROGRAM, AND ELECTRONIC DEVICE

(71) Applicant: JOININ GLOBAL PTE.LTD., SG (SG)

(72) Inventor: Hongbing ZHENG, Hangzhou (CN)

(73) Assignee: JOININ GLOBAL PTE.LTD., SG (SG)

(21) Appl. No.: 18/823,747

(22) Filed: Sep. 4, 2024

(51) Int. Cl. H05B 47/17; F21V 23/04; F21Y 103/10; H05B 47/11; H05B 47/14; H05B 47/16; H05B 47/165; H05B 47/19

(52) U.S. Cl. CPC H05B 47/17; F21V 23/0435; F21V 23/0464; H05B 47/11; H05B 47/14; H05B 47/16; H05B 47/165; H05B 47/19; F21Y 2103/10

(57) ABSTRACT

A lamp control method, a chip, a non-transitory computer-readable storage medium, a computer program, and an electronic device are provided. The lamp control method comprises acquiring a present working state of a lamp; determining a control priority of a voltage sensing function block and a control priority of a timing function block based on the present working state of the lamp to obtain a priority result; controlling the lamp to work based on the priority result. When the lamp is in the operating state, the control priority of the timing function block is configured to be higher than the control priority of the voltage sensing function block, such that the lamp is controlled to work based on the preset timing strategy, avoiding interference from other external light sources.

### FIELD OF THE INVENTION

The present disclosure relates to the technical field of solar-powered illumination, and in particular to a lamp control method, a chip, a non-transitory computer-readable storage medium, a computer program, and an electronic device.

### BACKGROUND OF THE INVENTION

LED light strings are widely used as lighting fixtures and are often combined with solar light strings. Solar-powered illumination typically involves using solar charging by placing the light string controller in a sunny location to generate power. Conventional solar-powered illumination often uses intelligent light sensing control, meaning the light string automatically turns off when the solar panel detects a certain level of light and turns on when the light level drops. However, traditional solar light strings can be affected by other light sources at night, impacting their effectiveness.

### SUMMARY OF THE INVENTION

The present disclosure provides a lamp control method, a chip, a non-transitory computer-readable storage medium, a computer program, and an electronic device, which mitigate the impact of other light sources at night, ensuring optimal lighting performance.

A first aspect of the present disclosure provides a lamp control method, comprising: acquiring a present working state of a lamp; determining a control priority of a voltage sensing function block and a control priority of a timing function block based on the present working state of the lamp to obtain a priority result; controlling the lamp to work based on the priority result.

In an embodiment of the first aspect, the present working state comprises one of an operating state, a standby state, and an off state.

In an embodiment of the first aspect, the acquiring of the present working state of the lamp comprises: receiving a remote switch signal and a mechanical switch signal each of which is configured for controlling the lamp; when the remote switch signal and the mechanical switch signal both indicate “on”, determining that the present working state of the lamp is the operating state; when the mechanical switch signal indicates “on” and the remote switch signal indicates “off”, determining that the present working state of the lamp is the standby state; and when the mechanical switch signal indicates “off”, determining that the present working state of the lamp is the off state.

In an embodiment of the first aspect, the determining of the control priority of the voltage sensing function block and the control priority of the timing function block based on the present working state of the lamp comprises: when the present working state of the lamp is the operating state, configuring the control priority of the timing function block to be higher than the control priority of the voltage sensing function block, such that the timing function block preferentially controls the lamp to work in a timing operation mode; when the present working state of the lamp is the standby state, configuring the control priority of the voltage sensing function block to be higher than the control priority of the timing function block, such that the voltage sensing function block preferentially controls the lamp to work in a light-sensing operation mode; and when the present working state of the lamp is the off state, controlling the lamp to be in a non-operating mode.

In an embodiment of the first aspect, the timing operation mode comprises controlling the lamp to work in a preset current varying manner based on a preset timing strategy.

In an embodiment of the first aspect, the controlling of the lamp to work in the preset current varying manner comprises: determining if a continuous operation duration of the lamp is less than a preset timing-operation duration of the lamp; if yes, controlling the lamp to continue working in the preset current varying manner; and if no, controlling the lamp to enter the light-sensing operation mode.

In an embodiment of the first aspect, when the continuous operation duration is less than the preset timing-operation duration and the remote switch signal and the mechanical switch signal are not received, controlling the lamp to continue working in the preset current varying manner.

In an embodiment of the first aspect, when the continuous operation duration is less than the preset timing-operation duration, the controlling of the lamp to continue to work in the preset current varying manner comprises: determining whether an environment where the lamp is located experiences a day-night transition; if no, controlling the lamp to continue working in the preset current varying manner; and if yes, activating the voltage sensing function block at an onset of the day-night transition, resetting the timing operation mode of the lamp by the voltage sensing function block to obtain a reset timing operation mode, and controlling the lamp to work in the reset timing operation mode.

In an embodiment of the first aspect, the preset current varying manner comprises controlling a power supply current of the lamp to gradually and regularly vary with an operation duration of the timing operation mode.

In an embodiment of the first aspect, the controlling of the power supply current of the lamp to gradually and regularly vary with the operation duration comprises: controlling the power supply current of the lamp to gradually and regularly decrease as the operation duration increases.

In an embodiment of the first aspect, the controlling of the power supply current of the lamp to gradually and regularly vary with the operation duration comprises: controlling the power supply current of the lamp to gradually and regularly increase as the operation duration increases.

In an embodiment of the first aspect, the light-sensing operation mode comprises controlling the lamp to work based on illumination of an environment where the lamp is located.

In an embodiment of the first aspect, the illumination of the environment where the lamp is located is assessed by an output voltage (or, OV) of a solar panel, and the solar panel powers the lamp. The controlling of the lamp to work based on the illumination of the environment where the lamp is located comprises: acquiring the output voltage of the solar panel; determining whether the output voltage is less than a preset voltage threshold (or, PVT); if yes, determining that the environment where the lamp is located is in nighttime, and controlling the lamp to work in the timing operation mode when the mechanical switch signal and the remote switch signal are not received; and if no, determining that the environment where the lamp is located is in daytime, and controlling the lamp to be in the non-operating mode when the mechanical switch signal and the remote switch signal are not received.

In an embodiment of the first aspect, when the environment where the lamp is located is in nighttime, the lamp is controlled to work in the timing operation mode when the mechanical switch signal and the remote switch signal are not received (that is, neither one is received); when the environment where the lamp is located is in daytime, the lamp is controlled to be in the non-operating mode when the mechanical switch signal and the remote switch signal are not received (that is, neither one is received).

In an embodiment of the first aspect, the controlling of the lamp to work in the timing operation mode comprises: when the lamp works in the timing operation mode, determining whether an environment where the lamp is located experiences a day-night transition; if no, controlling the lamp to continue working in the timing operation mode; and if yes, activating the voltage sensing function block at an onset of the day-night transition, resetting the timing operation mode of the lamp by the voltage sensing function block to obtain a reset timing operation mode, and controlling the lamp to work in the reset timing operation mode.

In an embodiment of the first aspect, when the environment where the lamp is located is in daytime, the controlling of the lamp to work based on the environment where the lamp is located comprises: receiving a remote switch signal and a mechanical switch signal each of which is configured for controlling the lamp; when the remote switch signal and the mechanical switch signal both indicate “on”, controlling the present working state of the lamp to be the operating state for continuous operation; when the mechanical switch signal indicates “on” and the remote switch signal indicates “off”, controlling the present working state of the lamp to be the standby state for continuous operation; and when the mechanical switch signal indicates “off”, controlling the present working state of the lamp to be the off state.

In an embodiment of the first aspect, the lamp comprises one or more light strings.

A second aspect of the present disclosure provides a chip for controlling a lamp. The chip comprises a storage unit and a processing unit. The storage unit is configured to store a computer program. The processing unit is configured to call the computer program to perform a lamp control method according to any one of the embodiments provided in the first aspect.

A third aspect of the present disclosure provides a non-transitory computer-readable storage medium having a computer program stored thereon. When the computer program is performed by a processor, a lamp control method according to any one of the embodiments provided in the first aspect is implemented.

A fourth aspect of the present disclosure provides a computer program. The computer program comprises one or more computer instructions to implement a lamp control method according to any one of the embodiments provided in the first aspect.

A fifth aspect of the present disclosure provides an electronic device. The electronic device comprises a memory and a processor. The memory is configured to store a computer program. The processor is configured to perform the computer program stored in the memory, so that the electronic device implements a lamp control method according to any one of the embodiments provided in the first aspect.

As described above, the lamp control method, the chip, the non-transitory computer-readable storage medium, the computer program, and the electronic device of the present disclosure have following advantages.

In the present disclosure, the control priority of the voltage sensing function block and the control priority of the timing function block are determined based on the present working state of the lamp, and the lamp works based on the priority result. When the present working state of the lamp is the operating state, the control priority of the timing function block is configured to be higher than the control priority of the voltage sensing function block, such that the lamp is controlled to work based on the preset timing strategy, avoiding interference from other external light sources. Additionally, when the lamp is active, it discharges based on a preset strategy, with the discharge current decreasing as the environment gets darker, which reduces the lamp's brightness as night falls, ensuring that the perceived brightness remains constant and extending the lamp's endurance. The lamp control method of the present disclosure offers two switch modes including mechanical control and remote control, allowing the lamp to be turned on and off normally during the day without being affected by light. The light-sensing operation mode is only active at night, with the discharge current decreasing as the environment gets darker, which reduces the lamp's brightness as night falls, ensuring that the perceived brightness remains constant and extending the lamp's endurance.

### BRIEF DESCRIPTION OF DRAWINGS

FIG. 1 shows a schematic diagram of a hardware scenario of a solar light string according to an embodiment of the present disclosure.

FIG. 2 shows a flowchart of a lamp control method according to an embodiment of the present disclosure.

FIG. 3 shows a flowchart of acquiring a present working state of a lamp according to an embodiment of the present disclosure.

FIG. 4 shows a flowchart of determining, based on the present working state of the lamp, a control priority of a voltage sensing function block and a control priority of a timing function block according to an embodiment of the present disclosure.

FIG. 5 shows a flowchart of a lamp control method according to another embodiment of the present disclosure.

FIG. 6 shows a schematic diagram of a chip according to an embodiment of the present disclosure.

FIG. 7 shows a schematic diagram of a lamp control device according to an embodiment of the present disclosure.

FIG. 8 shows a schematic diagram of a control circuit according to an embodiment of the present disclosure.

FIG. 9 shows a schematic diagram of a solar panel according to an embodiment of the present disclosure.

FIG. 10 shows a schematic diagram of an electronic device according to an embodiment of the present disclosure.

### REFERENCE NUMERALS

1 Solar panel
2 Lamp
3 Mechanical switch assembly
31 Mechanical switch button
4 Remote controller
10 Chip
110 Storage unit
120 Processing unit
20 Lamp
30 Lamp control device
310 Control circuit
3110 Chip
40 Wireless remote-control circuit
50 Remote controller
60 Solar panel
610 Solar charging circuit
620 Charging management circuit
630 Lithium battery protection circuit
70 Mechanical switch assembly
710 Mechanical switch button
80 Electronic device
810 Memory
820 Processor
S1˜Sn Steps S1 to Sn

### DETAILED DESCRIPTION OF THE INVENTION

The embodiments of the present disclosure will be described below. Those skilled can easily understand other advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the layout of the components can also be more complicated.

Embodiments of the present disclosure provide a lamp control method, a chip, a non-transitory computer-readable storage medium, a computer program, and an electronic device, which mitigate the impact of other light sources at night, ensuring optimal lighting performance.

The present disclosure uses several light strings as examples, suitable for wide areas such as parks and streets.

Embodiments of the present disclosure are described taking the power source being a solar panel as an example.

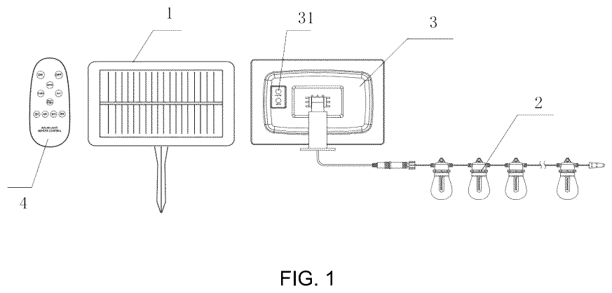

FIG. 1 shows a schematic diagram of a hardware scenario of a solar light string according to an embodiment of the present disclosure. The hardware scenario consists of a solar panel 1, a lamp 2, a mechanical switch assembly 3 and a remote controller 4. The solar panel 1 powers the lamp 2, and the lamp 2 is turned on or off by the remote controller 4 and/or a mechanical switch button 31 on the mechanical switch assembly 3. A control priority of the mechanical switch assembly 3 is configured to be higher than a control priority of the remote controller 4.

The principle and implementation of the lamp control method, the chip, the non-transitory computer-readable storage medium, the computer program, and the electronic device will be described in detail below in connection with the accompanying drawings, so that the skilled person in the field can understand them without creative labor.

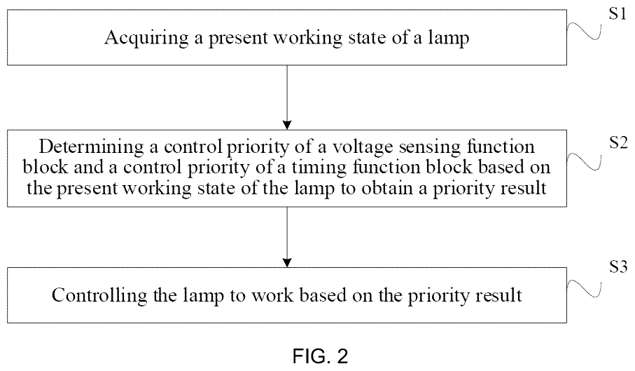

As shown in FIG. 2, the lamp control method of the present disclosure comprises steps S1-S3.

S1 includes acquiring a present working state of a lamp.

S2 includes determining a control priority of a voltage sensing function block and a control priority of a timing function block based on the present working state of the lamp to obtain a priority result.

S3 includes controlling the lamp to work based on the priority result.

Specifically, the lamp control method of the present disclosure uses a priority function block to determine the control priority of the voltage sensing function block and the control priority of the timing function block, based on whether the lamp is working or not. The voltage sensing function block takes priority when the lamp is not active, while the timing function block takes priority once the lamp starts working.

In other words, when the lamp starts working, the control priority of the timing function block becomes higher than that of the voltage sensing function block, and a subsequent program can be determined accordingly.

In one embodiment, the present working state comprises one of an operating state, a standby state, and an off state.

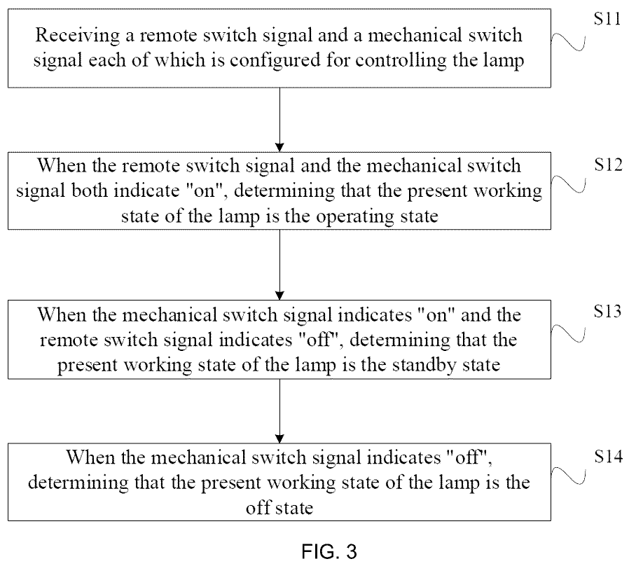

As shown in FIG. 3, the acquiring of the present working state of the lamp comprises steps S11-S14.

S11 includes receiving a remote switch signal and a mechanical switch signal, each of which is configured for controlling the lamp.

S12 includes: when the remote switch signal and the mechanical switch signal both indicate “on”, determining that the present working state of the lamp is the operating state.

S13 includes: when the mechanical switch signal indicates “on” and the remote switch signal indicates “off”, determining that the present working state of the lamp is the standby state.

S14 includes: when the mechanical switch signal indicates “off”, determining that the present working state of the lamp is the off state.

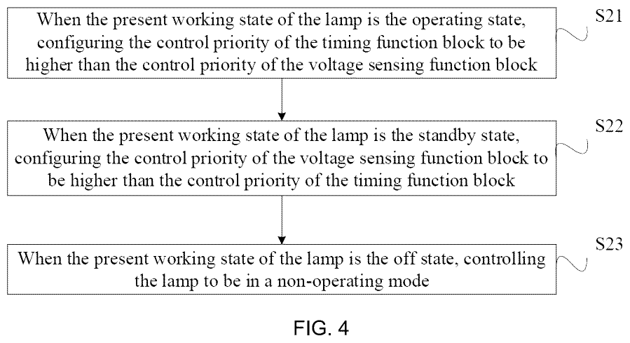

As shown in FIG. 4, the determining of the control priority of the voltage sensing function block and the control priority of the timing function block comprises steps S21-S23.

S21 includes: when the present working state of the lamp is the operating state, configuring the control priority of the timing function block to be higher than the control priority of the voltage sensing function block, such that the timing function block preferentially controls the lamp to work in a timing operation mode (or TOM).

S22 includes: when the present working state of the lamp is the standby state, configuring the control priority of the voltage sensing function block to be higher than the control priority of the timing function block, such that the voltage sensing function block preferentially controls the lamp to work in a light-sensing operation mode.

S23 includes: when the present working state of the lamp is the off state, controlling the lamp to be in a non-operating mode.

Specifically, when the present working state of the lamp is the operating state, the control priority of the timing function block is higher than the control priority of the voltage sensing function block, such that the lamp is controlled to work based on a preset timing strategy, avoiding interference from other external light sources. Additionally, when the present working state of the lamp is the operating state, the lamp discharges (or, in a discharging mode, DM) based on a preset strategy, with the discharge current decreasing as the environment gets darker, which reduces the lamp's brightness as night falls, ensuring that the perceived brightness remains constant and extending the lamp's endurance.

In one embodiment, the timing function block preferentially controls the lamp to work in the timing operation mode by steps S211A-S213A.

S211A includes: when the lamp works in the timing operation mode, determining whether an environment where the lamp is located experiences a day-night transition.

S212A includes: if no, controlling the lamp to continue working in the timing operation mode.

S213A includes: if yes, activating the voltage sensing function block at the onset of the day-night transition, resetting the timing operation mode of the lamp by the voltage sensing function block to obtain a reset timing operation mode, and controlling the lamp to work in the reset timing operation mode.

Specifically, in the timing operation mode, the lamp operates independently of illumination of the environment where the lamp is located. When the environment where the lamp is located experiences a day-night transition, the lamp's timer and brightness are reset.

That is, when the lamp is in the timing operation mode, there are two scenarios; when the timing function block is active and the environment where the lamp is located does not experience a day-night transition, the timing function block controls the lamp to continue working in the timing operation mode; and when the environment where the lamp is located experiences a day-night transition, the voltage sensing function block is activated at the onset of the day-night transition, resetting the timing operation mode (i.e., resetting the lamp's timer and brightness), and the timing function block then controls the lamp to work in the reset timing operation mode.

In one embodiment, the timing operation mode comprises controlling the lamp to work in a preset current varying manner based on a preset timing strategy.

In one embodiment, the controlling of the lamp to work in the preset current varying manner comprises steps S211B-S213B.

S211B includes: determining if a continuous operation duration of the lamp is less than a preset timing-operation duration of the lamp.

S212B includes: if yes, controlling the lamp to continue working in the preset current varying manner.

S213B includes: if no, controlling the lamp to enter the light-sensing operation mode.

In one embodiment, when the continuous operation duration is less than the preset timing-operation duration and the remote switch signal and the mechanical switch signal are not received, the lamp is controlled to continue working in the preset current varying manner.

Specifically, when the lamp works in the preset current varying manner, it will continue working in this manner if the continuous operation duration is less than the preset timing-operation duration and the remote switch signal and the mechanical switch signal are not received; once the mechanical switch signal or the remote switch signal is received during this period, the lamp will be controlled based on the received signal(s), as these signals have higher priority than the timing function block and the voltage sensing function block.

In one embodiment, when the continuous operation duration is less than the preset timing-operation duration, the controlling of the lamp to continue working in the preset current varying manner comprises steps S2121-S2123.

S2121 includes: determining whether an environment where the lamp is located experiences a day-night transition.

S2122 includes: if no, controlling the lamp to continue working in the preset current varying manner.

S2123 includes: if yes, activating the voltage sensing function block at the onset of the day-night transition, resetting the timing operation mode of the lamp by the voltage sensing function block to obtain a reset timing operation mode, and controlling the lamp to work in the reset timing operation mode.

Specifically, in the timing operation mode, when the timing function block is active and the environment where the lamp is located does not experience a day-night transition, the timing function block controls the lamp to continue working in the timing operation mode; and when the environment where the lamp is located experiences a day-night transition, the voltage sensing function block activates at an onset of the day-night transition, resetting the timing operation mode (i.e., resetting the lamp's timer and brightness), and the timing function block then controls the lamp to work in the reset timing operation mode.

In one embodiment, the preset current varying manner comprises controlling a power supply current of the lamp to gradually and regularly vary with an operation duration of the timing operation mode.

When the lamp starts operating, it works in the preset current varying manner based on the preset timing strategy. The power supply current of the lamp is controlled to gradually and regularly vary with the increasing operation duration of the timing operation mode, as long as the continuous operation duration is less than the preset timing-operation duration. Once the continuous operation duration reaches the preset timing-operation duration, the lamp enters the light-sensing operation mode.

In one embodiment, the controlling of the power supply current of the lamp to gradually and regularly vary with the operation duration comprises controlling the power supply current of the lamp to gradually and regularly decrease as the operation duration increases.

Specifically, from the moment the lamp starts illuminating until it turns off, it works in the preset current varying manner. In one embodiment, the power supply current of the lamp is controlled to gradually and regularly decrease as the operation duration increases. For example, its brightness is 8 times a base level in the first half hour, 4 times the base level in the next half hour, decreases gradually after the first hour until the fourth hour, and remains constant from the fourth hour until it is turned off, which matches the decreasing current with the darkening environment as night progresses, achieving a consistent lighting effect.

In another embodiment, the controlling of the power supply current of the lamp to gradually and regularly vary with the operation duration comprises controlling the power supply current of the lamp to gradually and regularly increase as the operation duration increases.

Specifically, from the moment the lamp starts illuminating until it turns off, it works in the preset current varying manner. In one embodiment, the power supply current of the lamp is controlled to gradually and regularly increase as the operation duration increases. For example, its brightness is 1 times a base level in the first half hour, 4 times the base level in the next half hour, increases gradually after the first hour until the fourth hour, and remains constant from the fourth hour until it is turned off. This setting is suitable for the period from night to morning (i.e., when the solar panel's output voltage is below a preset threshold), matching the increasing current with the brightening environment as dawn approaches, achieving a consistent lighting effect. The above settings are merely illustrative and can be adjusted based on actual needs.

In one embodiment, the light-sensing operation mode comprises controlling the lamp to work based on illumination of the environment where the lamp is located.

In one embodiment, the illumination of the environment where the lamp is located is assessed by the output voltage of the solar panel, and the solar panel powers the lamp.

In one embodiment, the controlling of the lamp to work based on the illumination of the environment where the lamp is located comprises steps S221-S224.

S221 includes: acquiring the output voltage of the solar panel.

S222 includes: determining whether the output voltage is less than a preset voltage threshold.

S223 includes: if yes, determining that the environment where the lamp is located is in nighttime, and controlling the lamp to work in the timing operation mode when the mechanical switch signal and the remote switch signal are not received.

S224 includes: if no, determining that the environment where the lamp is located is in daytime, and controlling the lamp to be in the non-operating mode when the mechanical switch signal and the remote switch signal are not received.

The time where the lamp is located can be determined using the voltage sensing function block. Specifically, when sunlight directly hits the solar panel, the output voltage of the solar panel is higher than the preset voltage threshold, and the voltage sensing function block determines that the environment is in daytime; when the output voltage of the solar panel is less than the preset voltage threshold, the voltage sensing function block determines that the environment is in nighttime. The lamp can be turned on and off normally during the daytime, with the mechanical/remote control switch signal having the highest priority.

In one example, the lamp remains turned off during the daytime (prioritizing the voltage sensing function block), then the lamp is automatically turned on when the nighttime starts, then the lamp remains turned on, unaffected by the illumination of the environment where the lamp is located (at which time the priority function block determines that the lamp is working, and the control priority of the timing function block becomes higher than the control priority of the voltage sensing function block), then the lamp is automatically turned off when the continuous operation duration reaches the preset timing-operation duration (at which time the priority function block prioritizes the voltage sensing function block), and then the lamp is turned on automatically when the next nighttime starts, so on and so forth.

In another example, the lamp is turned on at some point during the daytime (prioritizing the timing function block), and remains turned on when and after the nighttime starts, but the voltage sensing function block is activated at the onset of the day-night transition, resetting the timing operation mode (i.e., resetting the lamp's timer and brightness). Then the lamp is automatically turned off when the continuous operation duration reaches the preset timing-operation duration, at which time the priority function block prioritizes the voltage sensing function block. Then the lamp is turned on automatically when the next nighttime starts, so on and so forth.

In one embodiment, when the environment where the lamp is located is in nighttime, the lamp is controlled to work in the timing operation mode when the mechanical switch signal and the remote switch signal are not received (that is, neither one is received); when the environment where the lamp is located is in daytime, the lamp is controlled to be in the non-operating mode when the mechanical switch signal and the remote switch signal are not received (that is, neither one is received).

Specifically, when the environment where the lamp is located is in nighttime and the lamp is not controlled by the mechanical switch signal or the remote switch signal, the lamp enters the timing operation mode; and when the environment where the lamp is located is in daytime and the lamp is not controlled by the mechanical switch signal or the remote switch signal, the lamp enters the non-operating mode.

In one embodiment, the controlling of the lamp to work in the timing operation mode comprises steps S2231-S2233.

S2231 includes: when the lamp works in the timing operation mode, determining whether an environment where the lamp is located experiences a day-night transition.

S2232 includes: if no, controlling the lamp to continue working in the timing operation mode.

S2233 includes: if yes, activating the voltage sensing function block at an onset of the day-night transition, resetting the timing operation mode of the lamp by the voltage sensing function block to obtain a reset timing operation mode, and controlling the lamp to work in the reset timing operation mode.

In one embodiment, when the environment where the lamp is located is in daytime, the controlling of the lamp to work based on the environment where the lamp is located comprises steps S2241-S2244.

S2241 includes receiving a remote switch signal and a mechanical switch signal, each of which is configured for controlling the lamp.

S2242 includes: when the remote switch signal and the mechanical switch signal both indicate “on”, controlling the present working state of the lamp to be the operating state for continuous operation.

S2243 includes: when the mechanical switch signal indicates “on” and the remote switch signal indicates “off”, controlling the present working state of the lamp to be the standby state for continuous operation.

S2244 includes: when the mechanical switch signal indicates “off”, controlling the present working state of the lamp to be the off state.

Specifically, during the daytime, the lamp remains off unless activated by the remote switch signal or the mechanical switch signal, which takes priority over the timing function block and the voltage sensing function block.

In one embodiment, the lamp comprises one or more light strings and is controlled by both the remote switch signal and the mechanical switch signal. A control priority of the mechanical switch signal is configured to be higher than that of the remote switch signal, meaning the remote switch signal can only control the lamp when the mechanical switch signal indicates “on”. The present working state comprises one of the operating state and non-operating states, with the non-operating states including both the standby state and the off state.

Additionally, the lamp control method of the present disclosure allows the remote switch signal to adjust the lamp's brightness, working mode, and turn the lamp on or off at any time, regardless of the environment where the lamp is located.

In one embodiment, when the lamp is in the operating state, the control priority of the timing function block is higher than that of the voltage sensing function block, the lamp works in the timing operation mode following the preset timing strategy, until the continuous operation duration reaches the preset timing duration, and then the lamp enters the standby state and switches to the light-sensing operation mode; the voltage sensing function block judges the environment where the lamp is located by comparing the output voltage to the preset voltage threshold, if the output voltage is less than the preset voltage threshold, the voltage sensing function block determines that the environment is in nighttime, and the lamp enters the operating state; and if the output voltage is not less than the preset voltage threshold, the voltage sensing function block determines that the environment is in daytime, and the lamp remains in the standby state while the voltage sensing function block continuously monitors the output voltage and compares it with the preset voltage threshold.

In one embodiment, when the lamp works in the timing operation mode, the controlling of the lamp to work in the timing operation mode comprises determining whether an environment where the lamp is located experiences a day-night transition; if no, controlling the lamp to continue working in the timing operation mode; and if yes, activating the voltage sensing function block at an onset of the day-night transition, resetting the timing operation mode of the lamp by the voltage sensing function block to obtain a reset timing operation mode, and controlling the lamp to work in the reset timing operation mode.

Please note that the lamp can be manually turned on during the daytime. Regardless of when it is turned on, as long as it is working, it works in the preset current varying manner; when night falls, the lamp stays on, but the voltage sensing function block is activated at the onset of the day-night transition, resetting the timing operation mode (i.e., resetting the lamp's timer and brightness); then, the lamp is automatically turned off when the continuous operation duration reaches the preset timing-operation duration (at which time the priority function block prioritizes the voltage sensing function block); and then the lamp is turned on automatically when the next nighttime starts, so on and so forth.

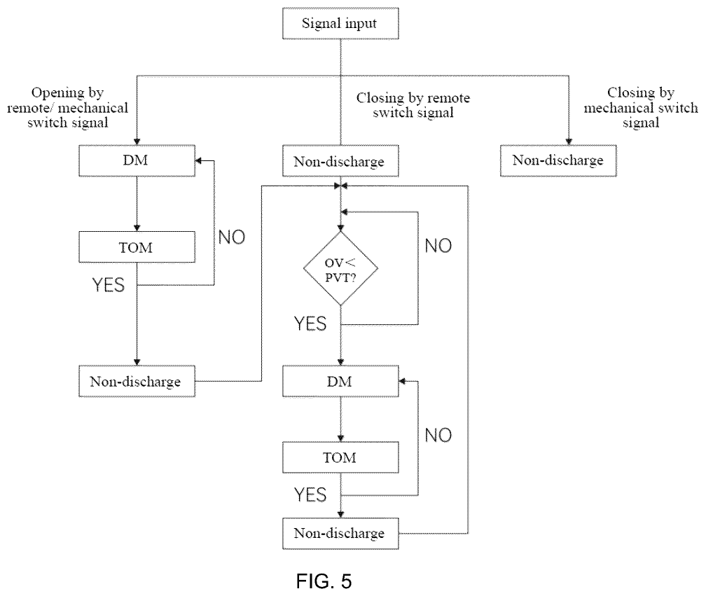

FIG. 5 shows a flowchart of a lamp control method according to another embodiment of the present disclosure. The detailed control method is described in the relevant part above, and will not be repeated here.

The mechanical switch signal has the highest priority and controls the lamp's power supply. The remote switch signal comes next in priority.

The lamp control method of the present disclosure uses a priority function block to determine the control priority of the voltage sensing function block and the control priority of the timing function block, based on whether the lamp is working or not. The voltage sensing function block takes priority when the lamp is not active, while the timing function block takes priority once the lamp starts working.

That is, when the lamp starts working, the control priority of the timing function block becomes higher than that of the voltage sensing function block, and a subsequent program can be determined accordingly.

The time where the lamp is located can be determined using the voltage sensing function block. Specifically, when sunlight directly hits the solar panel, the output voltage of the solar panel is higher than the preset voltage threshold, and the voltage sensing function block determines that the environment is in daytime; when the output voltage of the solar panel is less than the preset voltage threshold, the voltage sensing function block determines that the environment is in nighttime. The lamp can be turned on and off normally during the daytime, with the mechanical/remote control switch signal having the highest priority.

Typically, the lamp remains turned off during the daytime (prioritizing the voltage sensing function block), then the lamp is automatically turned on when the nighttime starts, then the lamp remains turned on, unaffected by the illumination of the environment where the lamp is located (at which time the priority function block determines that the lamp is working, and the control priority of the timing function block becomes higher than the control priority of the voltage sensing function block), then the lamp is automatically turned off when the continuous operation duration reaches the preset timing-operation duration (at which time the priority function block prioritizes the voltage sensing function block), and then the lamp is turned on automatically when the next nighttime starts, so on and so forth.

When the lamp is turned on at some point during the daytime (prioritizing the timing function block), and remains turned on when and after the nighttime starts, but the voltage sensing function block is activated at the onset of the day-night transition, resetting the timing operation mode (i.e., resetting the lamp's timer and brightness). Then the lamp is automatically turned off when the continuous operation duration reaches the preset timing-operation duration, at which time the priority function block prioritizes the voltage sensing function block. Then the lamp is turned on automatically when the next nighttime starts, so on and so forth.

The scope of the lamp control method described in the present disclosure is not limited to the sequence of operations listed herein. Any scheme realized by adding or subtracting operations or replacing operations of the traditional techniques according to the principle of the present disclosure is included in the scope of the present disclosure.

The present disclosure also provides a chip, the chip can implement the lamp control method described in the present disclosure, but the device for implementing the lamp control method described in the present disclosure includes, but is not limited to, the chip as described in the present disclosure. Any structural adjustment or replacement of the prior art made according to the principles of the present disclosure is included in the scope of the present disclosure.

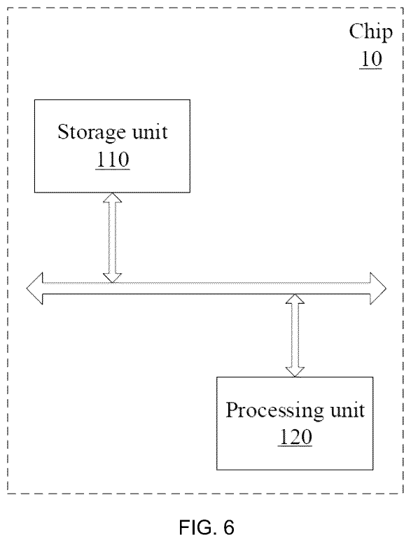

As shown in FIG. 6, the present disclosure provides a chip. The chip comprises a storage unit 110 and a processing unit 120. The storage unit 110 is configured to store a computer program. The processing unit 120 is configured to call the computer program to perform the above lamp control method.

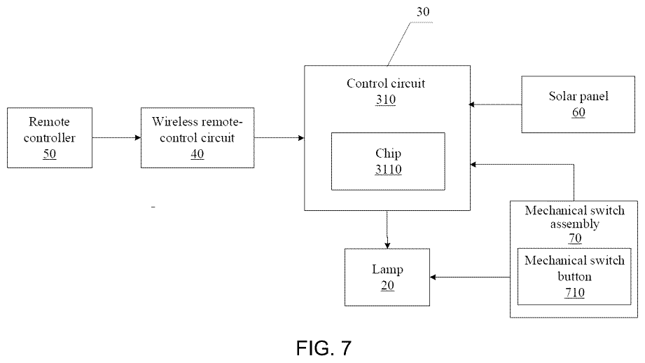

FIG. 7 shows a schematic diagram of a lamp control device 30 according to an embodiment of the present disclosure. The lamp control device 30 is configured to control a lamp 20. The lamp control device 30 comprises a control circuit 310. The control circuit 310 controls the lamp 20 to work in different working modes through a chip 3110. The chip 3110 is configured to obtain a present working state of the lamp 20, and determine a control priority of a timing function block and a control priority of a voltage sensing function block based on the present working state of the lamp 20, to control the lamp to work.

The control circuit 310 is communicatively connected to a wireless remote-control circuit 40 and receives a remote switch signal from a remote controller 50, to control the lamp 20 based on the remote switch signal.

The control circuit 310 is further communicatively connected to a solar panel 60 and a mechanical switch assembly 70. The solar panel 60 is configured to power the control circuit 310 and the lamp 20, and the control circuit 310 receives a mechanical switch signal from a mechanical switch button 710 of the mechanical switch assembly 70 and the remote switch signal from the remote controller 50 to determine the present working state of the lamp 20. In one embodiment, the mechanical switch assembly 70 is communicatively connected to the lamp 20 to turn it on or off.

In one embodiment, the chip may be a single-chip microcomputer.

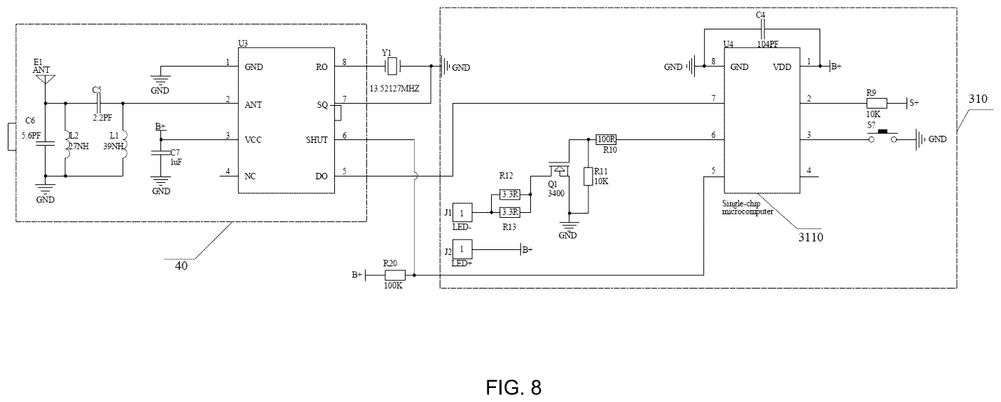

FIG. 8 shows a schematic diagram of the control circuit 310. The control circuit 310 receives the remote switch signal through the wireless remote-control circuit 40.

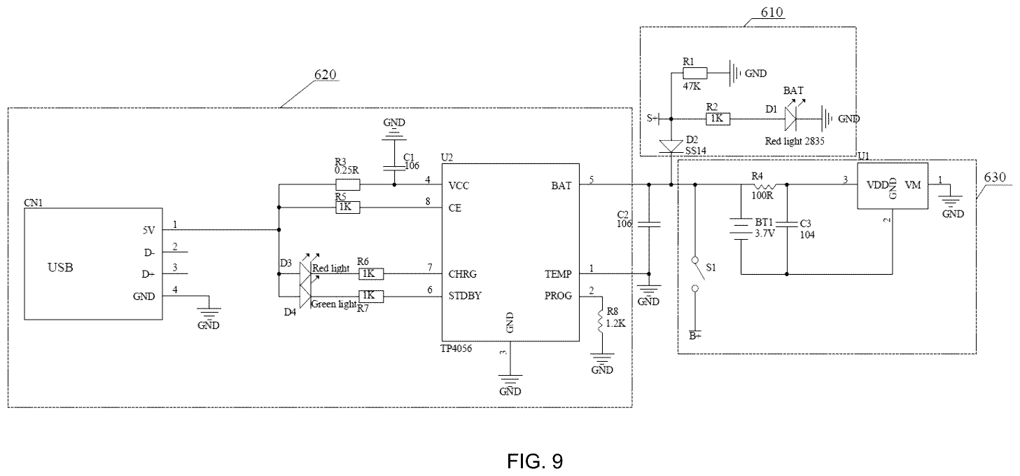

FIG. 9 shows a schematic diagram of the solar panel 60, which comprises a solar charging circuit 610, a charging management circuit 620, and a lithium battery protection circuit 630. The solar charging circuit 610 powers a lithium battery through the lithium battery protection circuit 630. The solar charging circuit 610 is communicatively connected to the control circuit 310, and the lithium battery powers the lamp 20 through the control circuit 310. The lamp 20 comprises one or more light strings, and the control circuit 310 switches working modes of the light strings through different pins on the single-chip microcomputer.

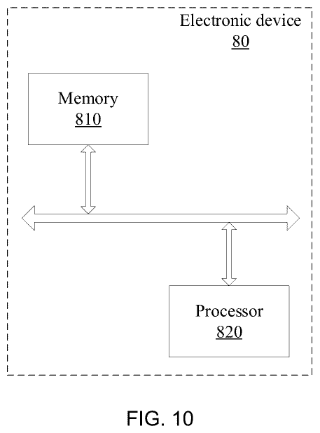

FIG. 10 shows a schematic diagram of an electronic device 80. The electronic device 80 comprises a memory 810 and a processor 820.

The memory 810 is configured to store a computer program.

The processor 820 is configured to perform the computer program stored in the memory 810, so that the electronic device 80 implements the above lamp control method.

The present disclosure further provides a non-transitory computer-readable storage medium configured to store a computer program. Those skilled in the art can understand that, all or part of the steps in the method for implementing the above embodiments can be implemented when the computer program is executed by a processor. The non-transitory computer-readable storage medium may be, for example, random access memory, read-only memory, flash memory, hard disk, solid-state disk, magnetic tape, floppy disk, optical disc and any combination thereof. The above storage medium can be any available medium that can be accessed by a computer, or a data storage device that integrates one or more available media, such as a server, a data center, etc. The available medium can be a magnetic medium (such as a floppy disk, a hard disk, or a magnetic tape), an optical medium (such as a digital video disc (DVD)), or a semiconductor medium (such as a solid state disk (SSD)), etc.

The present disclosure also provides a computer program. The computer program comprises one or more computer instructions. When these computer instructions are loaded and executed on a computing device, they generate all or part of the processes or functions described in the present disclosure. The computer instructions can be stored on a non-transitory computer-readable storage medium or transmitted from one medium to another, such as from a website, computer, or data center to another via wired (e.g., coaxial cable, optical fiber, digital subscriber line (DSL)) or wireless (e.g., infrared, wireless, microwave) means.

When executed by a computer, the computer program performs the above lamp control method. The computer program can be a software installation package, which can be downloaded and executed on a computer when using the above lamp control method.

In summary, the lamp control method, the chip, the non-transitory computer-readable storage medium, the computer program, and the electronic device of the present disclosure have following advantages.

1. The control priority of the voltage sensing function block and the control priority of the timing function block are determined based on the present working state of the lamp, and the lamp works based on the priority result; When the present working state of the lamp is the operating state, the control priority of the timing function block is configured to be higher than the control priority of the voltage sensing function block, such that the lamp is controlled to work based on the preset timing strategy, avoiding interference from external light sources other than sunlight. Additionally, when the lamp is active, its power module discharges based on a preset strategy, with the discharge current decreasing as the environment gets darker, which reduces the lamp's brightness as night falls, ensuring that the perceived brightness remains constant and extending the lamp's endurance.

2. The lamp control method of the present disclosure offers two switch modes including mechanical control and remote control, allowing the lamp to be turned on and off normally during the day without being affected by light.

3. The light-sensing operation mode is only active at night, with the discharge current decreasing as the environment gets darker, which reduces the lamp's brightness as night falls, ensuring that the perceived brightness remains constant and extending the lamp's endurance.

The descriptions of the steps or structures corresponding to the drawings are respectively emphasized, and some steps or structures that are not detailed can be referred to the relevant descriptions of other steps or structures.

The above-mentioned embodiments are merely illustrative of the principle and effects of the present disclosure instead of limiting the present disclosure. Modifications or variations of the above-described embodiments may be made by those skilled in the art without departing from the spirit and scope of the present disclosure. Therefore, all equivalent modifications or changes made by those who have common knowledge in the art without departing from the spirit and technical concept disclosed by the present disclosure shall be still covered by the claims of the present disclosure.

1. A lamp control method, comprising:
acquiring a present working state of a lamp;
determining a control priority of a voltage sensing function block and a control priority of a timing function block based on the present working state of the lamp to obtain a priority result; and
controlling the lamp to work based on the priority result.

2. The lamp control method according to claim 1, wherein the present working state comprises one of an operating state, a standby state, and an off state.

3. The lamp control method according to claim 1, wherein the acquiring of the present working state of the lamp comprises:
receiving a remote switch signal and a mechanical switch signal each of which is configured for controlling the lamp;
when the remote switch signal and the mechanical switch signal both indicate “on”, determining that the present working state of the lamp is the operating state;
when the mechanical switch signal indicates “on” and the remote switch signal indicates “off”, determining that the present working state of the lamp is the standby state; and
when the mechanical switch signal indicates “off”, determining that the present working state of the lamp is the off state.

4. The lamp control method according to claim 3, wherein the determining of the control priority of the voltage sensing function block and the control priority of the timing function block based on the present working state of the lamp comprises:
when the present working state of the lamp is the operating state, configuring the control priority of the timing function block to be higher than the control priority of the voltage sensing function block, such that the timing function block preferentially controls the lamp to work in a timing operation mode;
when the present working state of the lamp is the standby state, configuring the control priority of the voltage sensing function block to be higher than the control priority of the timing function block, such that the voltage sensing function block preferentially controls the lamp to work in a light-sensing operation mode; and
when the present working state of the lamp is the off state, controlling the lamp to be in a non-operating mode.

5. The lamp control method according to claim 4, wherein the timing operation mode comprises controlling the lamp to work in a preset current varying manner based on a preset timing strategy.

6. The lamp control method according to claim 5, wherein the controlling of the lamp to work in the preset current varying manner comprises:
determining if a continuous operation duration of the lamp is less than a preset timing-operation duration of the lamp;
if yes, controlling the lamp to continue working in the preset current varying manner; and
if no, controlling the lamp to enter the light-sensing operation mode.

7. The lamp control method according to claim 6, wherein when the continuous operation duration is less than the preset timing-operation duration and the remote switch signal and the mechanical switch signal are not received, controlling the lamp to continue working in the preset current varying manner.

8. The lamp control method according to claim 6, wherein when the continuous operation duration is less than the preset timing-operation duration, the controlling of the lamp to continue to work in the preset current varying manner comprises:
determining whether an environment where the lamp is located experiences a day-night transition;
if no, controlling the lamp to continue working in the preset current varying manner; and
if yes, activating the voltage sensing function block at an onset of the day-night transition, resetting the timing operation mode of the lamp by the voltage sensing function block to obtain a reset timing operation mode, and controlling the lamp to work in the reset timing operation mode.

9. The lamp control method according to claim 5, wherein the preset current varying manner comprises controlling a power supply current of the lamp to gradually and regularly vary with an operation duration of the timing operation mode.

10. The lamp control method according to claim 9, wherein the controlling of the power supply current of the lamp to gradually and regularly vary with the operation duration comprises:
controlling the power supply current of the lamp to gradually and regularly decrease as the operation duration increases.

11. The lamp control method according to claim 9, wherein the controlling of the power supply current of the lamp to gradually and regularly vary with the operation duration comprises:
controlling the power supply current of the lamp to gradually and regularly increase as the operation duration increases.

12. The lamp control method according to claim 4, wherein the light-sensing operation mode comprises controlling the lamp to work based on illumination of an environment where the lamp is located.

13. The lamp control method according to claim 12, wherein the illumination of the environment where the lamp is located is assessed by an output voltage of a solar panel, and the solar panel powers the lamp; wherein the controlling of the lamp to work based on the illumination of the environment where the lamp is located comprises:
acquiring the output voltage of the solar panel;
determining whether the output voltage is less than a preset voltage threshold;
if yes, determining that the environment where the lamp is located is in nighttime, and controlling the lamp to work in the timing operation mode when the mechanical switch signal and the remote switch signal are not received; and
if no, determining that the environment where the lamp is located is in daytime, and controlling the lamp to be in the non-operating mode when the mechanical switch signal and the remote switch signal are not received.

14. The lamp control method according to claim 4, wherein the controlling of the lamp to work in the timing operation mode comprises:
when the lamp works in the timing operation mode, determining whether an environment where the lamp is located experiences a day-night transition;
if no, controlling the lamp to continue working in the timing operation mode; and
if yes, activating the voltage sensing function block at an onset of the day-night transition, resetting the timing operation mode of the lamp by the voltage sensing function block to obtain a reset timing operation mode, and controlling the lamp to work in the reset timing operation mode.

15. The lamp control method according to claim 13, wherein when the environment where the lamp is located is in daytime, the controlling of the lamp to work based on the environment where the lamp is located comprises:
receiving the remote switch signal and the mechanical switch signal;
when the remote switch signal and the mechanical switch signal both indicate “on”, controlling the present working state of the lamp to be the operating state for continuous operation;
when the mechanical switch signal indicates “on” and the remote switch signal indicates “off”, controlling the present working state of the lamp to be the standby state for continuous operation; and
when the mechanical switch signal indicates “off”, controlling the present working state of the lamp to be the off state.

16. The lamp control method according to claim 1, wherein the lamp comprises one or more light strings.

17. A chip, comprising:
a storage unit, configured to store a computer program; and
a processing unit, configured to call the computer program to perform a lamp control method according to claim 1.

18. A non-transitory computer-readable storage medium, storing a computer program, wherein when the computer program is performed by a processor, a lamp control method according to claim 1 is implemented.

19. A computer program, wherein the computer program comprises one or more computer instructions to implement a lamp control method according to claim 1.

20. An electronic device, comprising a memory and a processor, wherein
the memory is configured to store a computer program; and
the processor is configured to perform the computer program stored in the memory, so that the electronic device implements a lamp control method according to claim 1.
